(19) United States
(12) Patent Application Publication
(10) Pub. No.: US 2005/0154090 A1
(43) Pub. Date: Jul. 14, 2005

(54) Polymer composition and method of rapid preparation in situ

(76) Inventor: Carmen Salvino, Schaumburg, IL (US)

Correspondence Address: JACKSON WALKER LLP, 2435 NORTH CENTRAL EXPRESSWAY, SUITE 600, RICHARDSON, TX, 75080, US

(21) Appl. No.: 11/042,247

(22) Filed: Jan. 25, 2005

Related U.S. Application Data
(63) Continuation-in-part of application No. 10/642,913, filed on Aug. 18, 2003.
Application No. 10/642,913 is a continuation of application No. 09/946,996, filed on Sep. 5, 2001, now abandoned.

(51) Int. Cl. C08L 63/00

(52) U.S. Cl. 523/400

(57) ABSTRACT

A polymer composition in a thermosetting resin admixture having a subcomponent gelled phase or polyurea. The gelled phase or polyurea is capable of trapping particles of widely differing particle densities within the polymer composition, thereby preventing these particles from either sinking or floating. The polymer composition can be cured in the normal fashion, yielding a useful filled polymer molded part with a substantially homogeneous density of particulate filler throughout. The gelled polyurea phase of the resin admixture is generated in situ during the mixture of the components of the thermosetting resin admixture. The polymer composition is particularly useful for the production of bowling balls, but may be used in any molded polymer parts.

This is a continuation-in-part application claiming priority to U.S. patent application Ser. No. 10/642,913, entitled “Polymer Composition and Method of Rapid Preparation In Situ” filed on Aug. 18, 2003, which is a continuation application claiming priority to U.S. patent application Ser. No. 09/946,996, entitled “Polymer Composition and Method of Rapid Preparation In Situ” filed on Sep. 5, 2001, the entire contents of both being hereby incorporated by reference.

### BACKGROUND

The present invention relates to a polymer composition and an in situ method of producing a polyurea to create an almost instantaneous, nonreversible, predictable, adjustable, and substantial viscosity increase in a thermosetting polymeric resin admixture.

Conventional methods of making particle filled thermosetting resin molded parts typically experience difficulties with particles either sinking or floating in the resin admixture used to mold the desired parts. The tendency for particulate fillers to sink or float in the resin admixture used to mold such parts has the effect of destroying the homogeneity of the resin admixture, thereby causing unwanted density gradients in the final molded parts.

Previously, those skilled in the art used thixotropic agents such as fumed silica or certain clays to build viscosity in the resin admixture and keep the particulate fillers suspended. However, these agents were of limited utility because the amount of viscosity build was limited, and because special high shear mixing equipment was required to shear the thixotropic agents into the resin prior to addition of the fillers. This high shear mixing equipment has a tendency to damage fragile, hollow, spherical glass bubble fillers, making them useless. Further problems occur due to the fact that the resin admixtures have to be kept constantly sheared to prevent the mix viscosity from starting to build before the resin admixture is transferred to the mold. Frequently, air entrapment or filler migration occurs because the thixotropic agent is not completely effective. Conventional thixotropic agents simply build viscosity without “freezing” the filler particles in place.

In some thermosetting resins, particularly polyurethanes and epoxies, said thermosetting resins get very hot, and actually undergo a substantial heat induced viscosity decrease before they gel. This heat induced viscosity decrease, prior to the gellation of the resin admixture, tends to exacerbate the tendency of the light or heavy filler particles to sink or float, thereby decreasing the ability of the molder to make molded parts without density gradients.

### SUMMARY

The present invention pertains to a polymer composition prepared from a thermosetting polymeric resin admixture having a subcomponent gelled phase or polyurea. The gelled phase or polyurea is capable of trapping particles of widely differing particle densities within the resin admixture, thereby preventing these particles from either sinking or floating. Subsequent to this rapid viscosity increase, the resin admixture can be cured in the normal fashion, yielding a useful filled polymer molded part. Because a very rapid and substantial viscosity build is accomplished in said resin admixture, and particles of widely varying densities are trapped in place, their movement through the resin admixture is prevented, resulting in the homogeneity of the resin admixture density being preserved, without any appreciable density gradients being formed in the resin admixture, or the resulting molded part. The gelled polyurea of the resin admixture is generated in situ and is evenly distributed throughout the resin admixture.

In contrast to conventional methods which rely upon thixotropic agents, the user of the current resin admixture can change the amounts and types of reactants used to cause the thickening to occur, giving the user precise control over the time and degree of viscosity build that occurs. This control over the timing and degree of viscosity build that occurs in the resin admixture is unavailable to a user of conventional thixotropic agents.

The rapid, suddenly-induced increase in viscosity of the resin admixture can be timed to occur in the mold, after it is filled, to fix the low or high density particles in place without density gradients. Thus, the resin admixture can first be mixed, de-aerated, and pumped or poured easily into the mold while still in a low viscosity state and without trapping excessive air bubbles. This eliminates the need for high shear mixing equipment and other equipment viscosity limitations. Once the resin admixture has been transferred to the mold, and the density has been fixed without density gradients, the resin admixture can be gelled and cured in the usual manner to produce the finished polymer composition.

The thermosetting resin admixture can utilize a combination of several reactive polymers, including but not limited to polyurethanes, epoxies, and unsaturated polyesters, and a combination of both low and high density fillers, either mineral or synthetic. The gelled polyurea phase within the resin admixture has the ability to trap, and hold in suspension, particulate matter or fillers of widely varying densities and in a wide range of amounts. The particulate matter may have a substantially higher, higher, lower, or substantially lower density than the density of the resin admixture, or may have a mixture of densities.

The ungelled phase of the resin admixture is composed of various thermosetting resins which can be solidified into a rigid resinous mass for the purpose of casting a wide variety of useful objects, these objects containing evenly distributed particulate matter, or blends of particulate matter, which impart desirable characteristics to the molded part. The desirable characteristics may include weight gain, weight reduction, increased or decreased abrasion resistance and wear properties, increased strength or toughness, improved impact resistance, increased or decreased coefficient of friction, increased or decreased coefficient of restitution, increased or decreased oil absorption properties, increased or decreased dielectric properties, or combinations of these properties.

The polymer composition is particularly useful in the production of bowling balls, although it is may be used in any molded polymer parts. The gelled polyurea phase maintains the uniformity of fillers and additives incorporated during the preparation of the molded polymer part. The fixation of the particulate matter within the gelled phase allows for the dramatic slowing of the gel and cure rate of the resin polymer used in the resin admixture, which subsequently results in a finished molded part which is much less likely to have defects such as burns and cracks. The burning and cracking are generally caused by an over-accelerated gel and cure rate. Surface quality is also improved, due to the reduced porosity caused by air entrapment.

Without wanting to be bound by theory, the technology behind the polymer composition in the thermosetting resin admixture is predicated on the relative kinetics of competing chemical reactions, and the excess amount of certain of those chemicals to limit molecular weight development of some products while at the same time providing a chemical supply for subsequent secondary reactions. Reactive components must be separated in different vessels prior to mixing, which initiates the chemical reactions. Inert fillers are maintained uniformly dispersed within the fluids of the individual vessels by continuous mixing or recirculation techniques commonly used and commercially available to those in the art.

### BRIEF DESCRIPTION OF DRAWINGS

FIG. 1 shows a general view of a method and apparatus for preparing the polymer composition.

### DETAILED DESCRIPTION OF PREFERRED EMBODIMENTS

The present invention relates to a polymer composition in a thermosetting resin admixture which includes as a subcomponent a gelled or polyurea phase. The in situ generation of the polyurea phase produces a substantial and controllable viscosity increase that enables the trapping and fixation of particulate matter within the resin admixture, eliminating density gradients. The resin admixture is useful for the production of any molded parts containing particulate matter, and particularly for the production of bowling balls.

Although other very rapidly gelling polymers could be used, the gelled phase within the resin admixture preferably comprises a polyurea. Polyurea (RNHCONHR) is a product of the reaction between an isocyanate (OCN—R) and a companion reactant such as an amine (RNH₂), carboxylic acid (RCOOH), or water (H₂O). In the presence of an excess amount of either isocyanate or companion reactant, the polyurea formed is of low molecular weight and is essentially a dimer. In the presence of approximately equal or non-limiting amounts of either isocyanate or companion reactant, the polyurea formed will be of higher molecular weight and will impart higher viscosity to the mixture. In preferred embodiments, the polyurea has a low number average molecular weight, from about 200 g/mole to about 2000 g/mole, and more preferably from about 200 g/mole to about 300 g/mole. Unless otherwise stated, molecular weight means number average molecular weight.

The polyurea gelled phase is produced in situ when all of the components for the resin admixture are mixed together. In a preferred embodiment, the polymer composition is prepared by mixing compounds comprising a polymer resin material, an isocyanate, a companion reactant, a filler material, and a plasticizer or diluent material. Only the isocyanate and the companion reactant react to form the polyurea.

Once the components are mixed, a primary and a secondary reaction occur. In the primary reaction, the polyurea is generally formed within 1 to 30 seconds. This allows the polyurea to be formed at the time of the molding, or just after the mold is filled. At this point, the polyurea is in a gelled phase but is still capable of being incorporated into the backbone of the polymer matrix. In the secondary reaction, polymerization occurs within the thermosetting resin admixture. With the appropriate selection of reactants and properties, the gelled polyurea holds the particulate filler mix in suspension while the secondary reaction proceeds. Upon completion of the secondary reaction, the gelled polyurea and any particulate filler contained therein are evenly dispersed throughout the cured polymer.

The primary reaction between the isocyanate and the companion reactant forming the polyurea is much faster (from 100 to 1000 times faster) than other competing reactions which could take place with the isocyanate, such as reactions with a primary alcohol (ROH). The polyurea-forming reaction is also much faster than other reactions with an amine, such as reactions with an epoxide. Thus, there is no reasonable likelihood that the secondary reaction or any competitive reaction will consume one of the essential reactants needed to produce the polyurea. Furthermore, there is no reaction between an isocyanate and an epoxide, or between an amine and a hydroxyl containing compounds, which allows for convenient separation of the reactants until polymerization and polyurea formation is desired. The formation of polyurea is accomplished in situ, which allows formation of the polyurea at the time of application or molding. After gellation, the polyurea is available to be incorporated into the backbone of the polymer matrix.

The polymer composition making up the resin admixture is preferably prepared by mixing compounds comprising, based on volume, from about 40 to about 68 percent of a polymer resin material, from about 0.1 to about 5 percent of an isocyanate, from about 2 to about 15 percent of a companion reactant such as an amine, from about 0.1 to about 13 percent of a filler material, and optionally from about 20 to about 35 percent of a plasticizer material and from about 0 to about 20 percent of a diluent material. A preferred embodiment utilizes a ratio of isocyanate to amine ranging from about 1:10 to about 1:40 based on volume.

Preferably, the components of the resin admixture are held separately in different vessels until the time that mixing and reaction is desired. In a preferred embodiment, a first vessel will contain a polymer resin material and an isocyanate. A second vessel may then contain an amine and a plasticizer or diluent material. A filler material may be present in either vessel. When the contents of the vessels are mixed, a polyurea of low molecular weight is formed immediately as a result of the primary reaction. The polyurea gel matrix then holds the filler in suspension during the interval required for the secondary reaction of the polymer resin to proceed to completion. The resulting polymer composition that is formed preferably contains by volume from about 1 to about 3 percent polyurea, from about 55 to about 75 percent cured epoxy polymer, from about 0.2 to about 30 percent particulate filler, and from about 0 to about 40 percent inert plasticizer or diluent material. These volume amounts may vary depending on the desired properties of the final polymer. The resulting polymer composition can be analyzed using a combination of techniques such as FTIR Spectroscopy, NMR Spectroscopy, HPLC, Mass Spectrometry and other analytical techniques commonly used in plastics characterization.

The polymer resin material may be a mixture of one or more epoxies, unsaturated polyesters, polyurethanes, or various other thermosetting plastics. Epoxies are monomers or pre-polymers that further react with curing agents to yield high performance thermosetting plastics. Epoxy resins are characterized by the presence of a three membered cyclic ether group. Unsaturated polyesters are macromolecules with polyester backbones derived from the interaction of unsaturated dicarboxylic or polycarboxylic acids or anhydrides and polyhydric alcohols. Polyurethanes contain urethane groups in their backbone. They are obtained by the reaction of a diisocyanate or polyisocyanate with a macroglycol (polyol), or with a combination of a polyol and a short chain glycol extender.

In a preferred embodiment, the polymer resin material is an epoxy resin material. Preferably, the epoxy resin material comprises a bisphenol-A epoxy resin. A bisphenol-A epoxy resin is the reaction product of epichlorohydrin and bisphenol-A. Examples of a bisphenol-A epoxy resin include Dow DER-331 (Dow Chemicals, Midland, Mich.), Shell Epon-828 (Shell Chemical Corporation, Houston, Tex.), and Shell Epon-826 (Shell Chemical Corporation). The epoxy resin is preferably an aromatic epoxy that causes tight cross-linking. In preferred embodiments of the resin admixture, the epoxy resin ranges from about 40 to about 68 weight percent of the resin admixture, preferably from about 44 to about 62 weight percent of the resin admixture, and most preferably from about 48 to about 58 weight percent of the resin admixture.

The isocyanate is preferably of low molecular weight and viscosity. An equivalent weight of from about 100 g/mole to about 140 g/mole is preferred. The viscosity of the isocyanate should preferably be below 200 cps at 25° C. Preferred examples of the isocyanate include aromatic poly (MDI) isocyanates, such as polymethylene polyphenylisocyanate, and aliphatic isocyanates, such as hexamethylene diisocyanate. Other preferred examples include 4,4-diphenylmethane diisocyanate, such as BASF M-20 MDI, a polymeric MDI (BASF Corporation, Wyandotte, Mich.). In preferred embodiments of the resin admixture, the diisocyanate ranges from about 0.1 to about 5 weight percent of the resin admixture, preferably from about 0.5 to about 3 weight percent of the resin admixture, and most preferably from about 1.5 to about 2 weight percent of the resin admixture.

The companion reactant which reacts with the isocyanate to form the polyurea is preferably an amine. The amine is preferably an aliphatic amine, such as n-aminoethylpiperazine (“AEP”), diethylenetriamine (“DETA”), or triethylenetriamine (“TETA”). Other preferred amines include tris (dimethyl amino-methyl phenol), tetraethylene pentamine (“TEPA”), and ethylenediamine. In preferred embodiments of the resin admixture, the amine ranges from about 2 to about 15 weight percent of the resin admixture, preferably from about 4 to about 10 weight percent of the resin admixture, and most preferably from about 5 to about 7 weight percent of the resin admixture. Other suitable companion reactants include carboxylic acids, such as carboxylic acid terminated polyesters, and water.

In further preferred embodiments, when used in combination with an epoxy resin having an equivalent weight of approximately 190, the amines can be used in the following amounts: AEP having an equivalent weight of about 43, at about 22.7 parts per hundred; DETA having an equivalent weight of about 20.7, at about 10.9 parts per hundred; TETA having an equivalent weight of about 24.5, at about 12.9 parts per hundred; tris (dimethyl amino-methyl phenol) at about 10 parts per hundred; TEPA having an equivalent weight of about 27, at about 14.2 parts per hundred; and ethylenediamine having an equivalent weight of about 60, at about 31.6 parts per hundred. Any combination of these amines may be used to cure an epoxy resin having an equivalent weight of approximately 190, so long as the equivalent weights of the amines add up to the amount needed to react with the resin. Thus, various blends of the listed amines can be used to develop the cure cycle and physical properties that are desired in the finished polymer.

A preferred embodiment of the modified epoxy resin may also contain a filler material. The filler material can have a density ranging from about 0.009 g/ml, such as a thermoplastic microballoon, to about 11.3 g/ml, such as lead powder, and may comprise from about 0.2 percent to about 30 percent by volume of the total polymer composition. Preferred examples of the filler material include solid glass spheres, such as Potters 300A (otters Industries, Valley Forge, Pa.), hollow glass spheres, such as Potters 110P8, Potters Q-300, Potters 6014, or Potters 6048 (Potters Industries), hollow thermoplastic spheres, such as Potters 6545 (Potters Industries), ground pumice (Smith Chemical and Wax of Savannah, Savannah, Ga.), or a combination thereof. Additional examples of the filler material include talc, silica, calcium carbonate, fiberglass, ground glass, diatomaceous earth, polyethylene, wood flour, titanium dioxide, white rubber, calcium sulfate, gold mica, silver mica, lead powder, iron, iron oxide, carbon, or any other filler known in the art. Useful inert fillers are capable of enhancing various specific properties of the finished molded part, such as density, frictional properties, coefficient of restitution, fire resistance, abrasion resistance, dielectric properties, and magnetic properties. In preferred embodiments of the polymer composition, the filler material ranges from about 0.1 to about 13 weight percent of the resin admixture, preferably from about 0.2 to about 11 weight percent of the resin admixture, and most preferably from about 0.5 to about 9 weight percent of the resin admixture.

Preferred embodiments of the polymer composition may contain one or more plasticizer or diluent materials. The plasticizer material can be made from one or more plasticizers. Various plasticizers may be added to modify the physical properties of elasticity, hardness, and flexibility of the molded part. The plasticizers may be incorporated at levels of between about 0 and 40 percent by volume, depending on the type of polymer used in the resin admixture, and the specific properties the user wishes to achieve in the finished molded part. Preferred examples of the plasticizer material include 2,2-trimethyl-1,3-pentanediol-diisobutyrate, such as Eastman TXIB (Eastman Chemicals, Kingsport, Tenn.), a chlorinated paraffin hydrocarbon wax, such as Dover Chlorowax C-40 (Dover Chemicals, Dover, Ohio), dialkyl phthalate, such as BASF Palatinol 711-P (BASF Corporation), dibutyl phthalate, texanol ester alcohol, such as Eastman TEX (Eastman Chemicals), sucrose acetate isobutyrate, such as Eastman SAIB (Eastman Chemicals), dioctyl phthalate, dioctyl adipate, diisooctyl phthalate, ditridecyl phthalate, butyl benzyl phthalate, oleic acid, alphamethylstyrene, benzoate ester, such as Velsicol Benzoflex 2088 (Velsicol Company, Rosemount, Ill.), hydrocarbon polystyrene resin, such as Eastman Piccolastic A-5 (Eastman Chemicals), urethane polyether polyol, polyoxyalkylene polyol, such as BASF Pluracol GP-730 (BASF Corporation), polyhydroxy amine, such as BASF Quadrol (BASF Corporation), or Bayer Multranil 9157 (Bayer Corporation, Pittsburgh, Pa.), or a combination thereof. In preferred embodiments of the resin admixture, the plasticizer material ranges from about 20 to about 35 weight percent of the resin admixture, preferably from about 25 to about 33 weight percent of the resin admixture, and most preferably from about 28 to about 31 weight percent of the resin admixture.

Preferred embodiments of the modified epoxy resin may also contain one or more diluents, such as Cardiolite Diluent NC-700 (Cardiolite Company). In preferred embodiments of the polymer composition, the diluent ranges from about 0 to about 20 weight percent of the resin admixture, preferably from about 0 to about 15 weight percent of the resin admixture, and most preferably from about 0 to about 10 weight percent of the resin admixture.

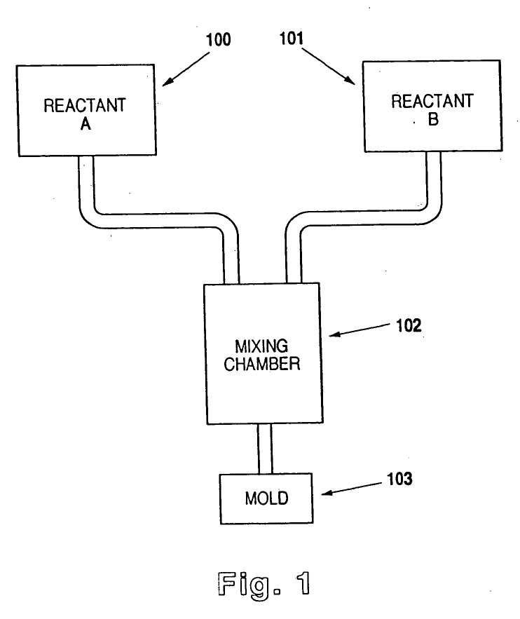

As shown in FIG. 1, a preferred method of preparing the polymer composition begins with placing the reactants which form the polyurea gelled phase in separate containers. A first vessel 100 can hold the isocyanate, or Reactant A, and a second vessel 101 can hold the amine, or Reactant B. In addition, between about 45 and 65 percent by volume of the liquid reactants, such as the epoxy resin material, can be placed into the first vessel 100. The remainder of the liquid reactants, such as the plasticizer or diluent material, can be placed into the second vessel 101. A particulate filler may be added to either or both vessels. The contents of both the first vessel 100 and the second vessel 101 are then mixed in a mixing chamber 102, which initiates the primary and secondary reactions. The preferred manner of this mixing is with an impingement mixer, but in cases where low density, hollow glass or plastic fillers are being used, some of these fillers carmot withstand the shear generated by the impingement mixer without breakage. In these cases, a motorized mechanical mixing chamber may be used in place of the impingement mixer. In cases where very low density hollow glass or plastic fillers are being used, and impingement or motorized mixing chambers would fracture or collapse the hollow spheres, a simple static mixing tube may be used. The main advantage to the impingement mixer is its low contained volume, which makes it possible to utilize a fast-reacting polyurea. For the mechanical mixer and the static mixing tube methods, a slower reacting gel phase must be used to prevent gelling of the material in the mixing device. Frequent flushing of mix heads may also be useful, but this may require excessive solvent use and result in higher material costs.

Finally, the mixed fluids are poured into a mold 103 in any desired shape. Alternatively, the fluids can be poured onto a substrate or core (such as a bowling ball inner core) within a mold, thus creating an outer layer for the substrate or core. The present invention also pertains to a bowling ball prepared by this method.

The polymer composition can be used in the manufacture of various polymeric molded parts. The polymer composition can be applied especially well to the manufacture of bowling balls, and particularly to the manufacture of bowling balls which incorporate various particulate fillers and plasticizers to enhance bowling ball performance. It is understood by those of skill in the art that current types of bowling ball manufacturing equipment can be used to produce bowling balls incorporating the polymer composition. Neither additional new equipment nor modifications to existing equipment is required in most cases in order to make use of the polymer composition.

Bowling balls containing an inner core and an outer core are known in the art. In addition, it is understood by those skilled in the art that the polymer composition can be applied to any typical bowling ball utilizing conventional materials. Such conventional shell materials may include, but are not limited to, unsaturated polyesters, polyurethanes, and epoxies of various types. One or more inner cores or outer shells of the same or varying compositions may be used within the bowling ball and provided for in the same manner as for a bowling ball having a single inner core and a single outer shell or layer. Both the inner core and the outer shell may be manufactured of such materials as are known in the art. The polymer composition can be used in both the inner core and in the outer shell to restrict the movement of particulate matter through the core or shell and thus prevent undesirable density gradients from being formed.

Although the polymer composition has been described with reference to specific embodiments, and specifically to bowling balls, the polymer composition is generally and widely useful and is applicable to many other embodiments and products other than bowling balls. This description should not be limited or construed in a limited manner, but rather should be considered to pertain to a very general process which may be useful for a wide range of embodiments requiring density gradient control of polymeric resin admixtures containing a wide variety of particulate fillers. Various embodiments will become apparent to those skilled in the art after reading the description.

### EXAMPLE 1

### Example Resin Admixtures Used to Produce Example Polymer Compositions

The Tables below show nine different resin admixtures which were mixed according to the methods described in order to produce examples of the polymer composition.

TABLE 1-1
Resin Admixture A

| First Vessel | | Second Vessel | |
|---|---|---|---|
| Ingredient | % (wt) | Ingredient | % (wt) |
| Epoxy resin (Epon 828) | 53.0 | Filler material (Mica) | 3.8 |
| Isocyanate | 1.2 | Plasticizer (Eastman TXIB) | 32.0 |
| | | Amine | 10.0 |
| | | (Aminoethylpiperazine) | |

TABLE 1-2
Resin Admixture B

| First Vessel | | Second Vessel | |
|---|---|---|---|
| Ingredient | % (wt) | Ingredient | % (wt) |
| Epoxy resin | 56.0 | Filler material (solid glass spheres) | 3.8 |
| (Epon 828) | | Plasticizer (Velsicol Benzoflex 2088) | 27.5 |
| Isocyanate | 1.2 | Amine (Aminoethylpiperazine) | 11.5 |

TABLE 1-3
Resin Admixture C

| First Vessel | | Second Vessel | |
|---|---|---|---|
| Ingredient | % (wt) | Ingredient | % (wt) |
| Epoxy resin | 56.0 | Filler material (Potters Q-300) | 4.0 |
| (Epon 828) | | Plasticizer (Eastman TXIB) | 27.3 |
| Isocyanate | 1.2 | Amine (Aminoethylpiperazine) | 11.5 |

TABLE 1-4
Resin Admixture D

| First Vessel | | Second Vessel | |
|---|---|---|---|
| Ingredient | % (wt) | Ingredient | % (wt) |
| Epoxy resin (Epon 828) | 53.0 | Filler material (Pumice) | 3.0 |
| Isocyanate | 1.5 | Plasticizer (Eastman TXIB) | 33.5 |
| | | Amine | 9.0 |
| | | (Aminoethylpiperazine) | |

TABLE 1-5
Resin Admixture E

| First Vessel | | Second Vessel | |
|---|---|---|---|
| Ingredient | % (wt) | Ingredient | % (wt) |
| Epoxy | 58.0 | Filler material (Potters Q-300) | 4.0 |
| resin (Epon 828) | | Filler material (Rubber) | 1.0 |
| Isocyanate | 1.2 | Plasticizer (Eastman TXIB) | 25.8 |
| | | Amine (Aminoethylpiperazine) | 10.0 |

TABLE 1-6
Resin Admixture F

| First Vessel | | Second Vessel | |
|---|---|---|---|
| Ingredient | % (wt) | Ingredient | % (wt) |
| Epoxy | 58.0 | Filler material (Potters 6014) | 1.2 |
| resin (Epon 828) | | Filler material (Rubber) | 9.0 |
| Isocyanate | 1.2 | Plasticizer (Eastman TXIB) | 20.6 |
| | | Amine (Aminoethylpiperazine) | 10.0 |

TABLE 1-7
Resin Admixture G

| First Vessel | | Second Vessel | |
|---|---|---|---|
| Ingredient | % (wt) | Ingredient | % (wt) |
| Epoxy | 59.0 | Filler material (Rubber) | 9.0 |
| resin (Epon 828) | | Plasticizer (Eastman TXIB) | 18.3 |
| Isocyanate | 1.9 | Amine (Aminoethylpiperazine) | 11.8 |

TABLE 1-8
Resin Admixture H

| First Vessel | | Second Vessel | |
|---|---|---|---|
| Ingredient | % (wt) | Ingredient | % (wt) |
| Epoxy resin (Epon 828) | 55.0 | Plasticizer (Eastman TXIB) | 33.9 |
| Isocyanate | 2.1 | Amine | 9.0 |
| | | (Aminoethylpiperazine) | |

TABLE 1-9
Resin Admixture I

| First Vessel | | Second Vessel | |
|---|---|---|---|
| Ingredient | % (wt) | Ingredient | % (wt) |
| Epoxy | 57.0 | Filler material (Potters 6545) | 0.29 |
| resin (Epon 828) | | Filler material (Rubber) | 9.0 |
| Isocyanate | 1.7 | Plasticizer (Eastman TXIB) | 20.51 |
| | | Amine (Aminoethylpiperazine) | 11.5 |

1. A polymer composition comprising, on a volume percent basis:
from about 1 to about 3 percent of a polyurea;
from about 55 to about 75 percent of a cured epoxy polymer; and
from about 0.2 to about 30 percent of a filler material,
wherein the polyurea has a molecular weight of from about 200 g/mole to about 2000 g/mole, wherein the polyurea holds the filler material in suspension, wherein the polyurea is an in situ reaction product of an amine and an isocyanate, and wherein the ratio of amine to isocyanate is from about 1:10 to about 1:40.

2. The polymer composition of claim 1 further comprising, on a volume percent basis, up to about 40 percent of a plasticizer or diluent material.

3. A polymer composition prepared by mixing compounds comprising an epoxy resin, an isocyanate, a filler material, and an amine.

4. The polymer composition of claim 3, wherein, on a weight percent basis, the compounds comprise:
from about 40 to about 68 percent of an epoxy resin;
from about 0.1 to about 5 percent of an isocyanate;
from about 0.1 to about 13 percent of a filler material; and
from about 2 to about 15 percent of an amine.

5. The polymer composition of claim 4, wherein the epoxy resin comprises a bisphenol-A epoxy resin.

6. The polymer composition of claim 4, wherein the isocyanate has an equivalent weight of from about 100 g/mole to about 140 g/mole.

7. The polymer composition of claim 4, wherein the filler material comprises solid glass spheres, hollow glass spheres, hollow thermoplastic spheres, pumice, or rubber.

8. The polymer composition of claim 4, wherein the filler material has a density from about 0.009 g/ml to about 11.3 g/ml.

9. The polymer composition of claim 4, wherein the amine comprises aminoethylpiperazine.

10. The polymer composition of claim 4, further comprising a plasticizer material.

11. The polymer composition of claim 10, wherein the plasticizer material comprises 2,2-trimethyl-1,3-pentanediol-diisobutyrate or benzoate ester.

12. The polymer composition of claim 10, wherein the plasticizer material ranges from about 20 to about 35 weight percent.

13. The polymer composition of claim 4, further comprising a diluent.

14. The polymer composition of claim 13, wherein the diluent ranges from about 0 to about 20 weight percent.

15. A method of making a polymer composition having a polyurea component comprising:
mixing an epoxy resin and an isocyanate in a first vessel to give a first homogeneous mixture;
mixing an amine and a filler material in a second vessel to give a second homogeneous mixture;
blending the first homogeneous mixture and the second homogeneous mixture to give a polymerization mixture; and
pouring the polymerization mixture into a mold, wherein the isocyanate and the amine first react in a primary reaction to form a polyurea which holds the filler material in suspension, and wherein the epoxy resin and the amine react in a secondary reaction to form the polymer composition.

16. The bowling ball prepared by the method of claim 15.
